(19) United States
(12) Patent Application Publication
(10) Pub. No.: US 2024/0263779 A1
(43) Pub. Date: Aug. 8, 2024

(54) RECUPERATOR BURNER WITH A RECUPERATOR FOR GUIDING COUNTER-FLOWING FLUIDS

(71) Applicants: Schunk lngenieurkeramik GmbH, Willich (DE); Kueppers Solutions GmbH, Dortmund (DE)

(72) Inventors: Detlef BRANDS, Meerbusch (DE); Lars SCHNETTER, Wimbach (DE); Kamil WLOTZKA, Willich (DE); Jens TE KAAT, Dortmund (DE)

(21) Appl. No.: 18/570,352

(22) PCT Filed: Jun. 21, 2021
(86) PCT No.: PCT/EP2021/066827

§ 371 Date: Dec. 14, 2023

(30) Foreign Application Priority Data
Jun. 18, 2021 (WO) PCT/EP2021/066647

(51) Int. Cl. F23L 15/04; F23D 14/66

(52) U.S. Cl. CPC F23L 15/04; F23D 14/66

(57) ABSTRACT

Recuperator burner including a recuperator, which has two separate flow systems provided for guiding counter-flowing fluids, each system including at least one flow channel being open on both sides, and the at least two fluids entering/leaving via intake inputs and offtake outputs at opposite ends of the burner inlet and burner outlet, and one of the fluids is set up by a combustion air to be preheated and the other by an exhaust gas of the burner, wherein the recuperator accommodates the two flow systems in a heat transfer body which is made of one piece and whose jacket-shaped outer wall section at the burner inlet defines a flow pot including said input and output integrally attached.

The invention relates to a recuperator burner with a recuperator for guiding counter-flowing fluids according to the preamble of claim 1.

The efficiency of recuperator burners is increased by exchanging heat between the burner supply air and the exhaust gas flow of the burner. The recuperator, which exchanges heat between these two gas flows, is used for this purpose. The recuperator can be made of different materials, in particular metallic and ceramic materials. In particular, metallic materials are provided for low and medium temperature zones and ceramic materials for high temperature zones. By using a combination of materials, the individual sections of the recuperator can be optimized for good heat transfer.

A recuperator made of ceramic material for a recuperative burner is known from DE 196 16 288 A1. The recuperator comprises an inner tube, an outer tube and a heat-transferring intermediate tube. The intermediate tube divides an annular space between the inner tube and the outer tube into two concentric, essentially ring-shaped channels. The combustion air to be preheated flows through the inner channel, while the exhaust gas from the burner flows through the outer channel.

Compared to steel recuperators, ceramic recuperators have the great advantage of higher temperature resistance. This advantage comes at the cost of significantly lower efficiency if ceramic tubes are manufactured as smooth tubes or corrugated tubes with a correspondingly limited heat transfer surface. To improve efficiency, it is known to increase the heat transfer surface. For this purpose, the wall of the intermediate tube can be curved, at a number of points distributed over the length and circumference, outwards to form outward-facing nubs and inwards to form inward-facing nubs.

The nubs cause a considerable increase in the heat-transferring surface of the intermediate tube and thus a significant increase in the efficiency of the recuperator. The oppositely directed nubs form depressions so that the gases are alternately compressed and expanded on their flow path. This results in straight flow paths with successive constrictions and expansions along the length of the intermediate tube. This creates uniform flow conditions over the length of the recuperator, avoiding boundary layer formation. This results in flow conditions that bring the efficiency of the recuperator close to that of a ripped steel recuperator. The entire recuperator consists of silicon infiltrated silicon carbide (SiSiC).

A recuperator burner with a ceramic recuperator is known from EP 1 486 728 B1, which has pleats extending in the longitudinal direction of the recuperator to increase the heat exchange surfaces. The pleats are bent gradually, in particular undulated. This is intended to ensure a large heat exchange surface. Optimized heat transfer is to be achieved by designing the shape and number of pleats. The recuperator is preferably made of SiC ceramic and is preferably manufactured as a slip-cast part.

DE 195 41 922 C2 discloses a ceramic recuperator for a recuperative burner, which also consists of a tube section. This recuperator tube has a combustion chamber at the end and is used to separate outflowing combustion gases and incoming combustion air and to exchange heat between them. Radial serrations formed on the recuperator increase the surface area of the recuperator and improve the heat transfer from combustion gases to combustion air. The serrations repeatedly tear open the flow boundary layer both on the outside of the recuperator and on its inside, which significantly increases the heat transfer compared to smooth surfaces. The ceramic combustion chamber held in the recuperator can be made of silicon carbide. If the tube section of the recuperator is formed in one piece with the combustion chamber at the end, this results in a simple and robust design. The wall of the combustion chamber is smooth. The combustion chamber can be formed on the recuperator during production using the slip casting process without any additional effort. SiC ceramic is particularly suitable as a ceramic material for the recuperator, as it has a fitting heat resistance and thermal conductivity.

The known ceramic recuperators are therefore based on tube sections with a complexly shaped surface to increase the heat exchange surface. These structured surfaces tend to become rounded, especially when the recuperator is made of ceramic. Furthermore, precise and cost-effective production is not possible.

An object of the invention is therefore to provide a recuperator burner comprising a recuperator for guiding counter-flowing fluids, which ensures good heat transfer and at the same time enables cost-effective manufacture.

This object is solved by the features of claim 1.

Herewith provided is a recuperator burner, comprising a recuperator which accommodates the two flow systems for the counter-flowing fluids in a heat transfer body being made from one piece. According to the invention, it is also provided that the heat transfer body forms a flow pot at the end with which the burner inlet is associated, that flow pot integrally connecting the input for combustion air to be preheated and the output for exhaust gas.

The shape of the heat transfer body, comprising a flow pot, defines an outer wall of the heat transfer body at the burner inlet as a kind of vessel wall that surrounds an interior space. Flow paths can be set up in this interior space for passing-in or passing-out of fluid flows.

As the flow pot is made by a material extension of the heat transfer body in one outer border area only, an inner body section, that is penetrated by the flow channels, can end like a pot bottom regarding the flow pot or protrude into the flow pot with a heat exchanger prolongation. An increase in heat exchanger performance can be achieved in this way in conjunction with an integrally forming of the necks for the inlet and outlet of the flowing fluids. Discontinuities due to connection points are avoided. This increases wear resistance and opens up options for improved integration of the recuperator into the recuperator burner.

Preferably, a monolithic spatial shape can be chosen for the heat transfer body for unifying the flow systems that are provided for guiding counter-flowing fluids. Flow channels extending in the longitudinal direction of the recuperator can be created, which develop meandering flow fields, for example.

Additive manufacturing can be used to create heat exchanger structures that have cell structures with triple periodic minimum surfaces, e.g. as a gyroid, double gyroid, gyroid with cubically arranged cell structure, cylindrically arranged cell structure or spherically arranged cell structure. The flow rate of the fluids can be optimized by selecting the cell structure. The flow lengths can be increased according to the invention without causing significant constrictions or expansions, as is the case in the prior art.

The recuperator according to the invention can be made of metallic and/or ceramic materials. The cold/cooler combustion air or fresh air can also flow more effectively into the recuperator via the flow pot, both in terms of flow technology and to increase the efficiency of the heat exchange. The space in the heat transfer body can be used to create a flow field inside the heat transfer body.

Flow channels provided in the heat transfer body, especially if several are preferably routed in the longitudinal direction of the recuperator, can be cut/opened at one end of the burner inlet, allowing a quasi-simultaneous inflow via the aforementioned input.

According to the invention, it has surprisingly been found that not only the increase in the heat transfer surface improves the heat transfer, but also the flow conditions in the flow channels are of particular importance. The integrally connection is a function-enhancing connection, particularly for the combustion air intake at the burner inlet, as an additional usable heat exchanger surface can be generated. Consequently, the heat transfer surface can also be increased in accordance with the invention.

Particularly preferably, the heat exchanger body has a gyroid structure as a special design of a triple periodic minimal surface (TPMS), which can, for example, divide the space of the heat exchanger into two identical flow systems, namely of paths that do not cross and can run in the longitudinal direction of the recuperator. Further flow channels for at least a third and/or fourth fluid can be integrated into the heat transfer body, particularly in conjunction with a gyroid structure. The flow channels can also be divided into partial flow channels, which can be acted upon jointly via the flow pot in a main flow.

Advantages of a preferably all-ceramic design of the recuperator with intake inputs, offtake outputs and combustion chamber, i.e. the integration of all relevant assemblies of a recuperator burner, are further the minimization of connection interfaces. The advantages of the solution according to the invention also include the increase in efficiency due to the positive material properties (e.g. high thermal conductivity) and a 3D-printable material variant made of reaction-bonded silicon carbide (RBSiC).

Lower maintenance costs are also achieved by eliminating the steel and copper materials originally intended for the recuperator area.

A preferably monolithic design of the individual areas up to the one-piece (all-ceramic) recuperator can be realized by using 3D technology for the material RBSiC.

Further embodiments and advantages of the invention can be learnt from the following description and the dependent claims.

The invention is explained in more detail below with reference to the embodiments shown in the attached figures.

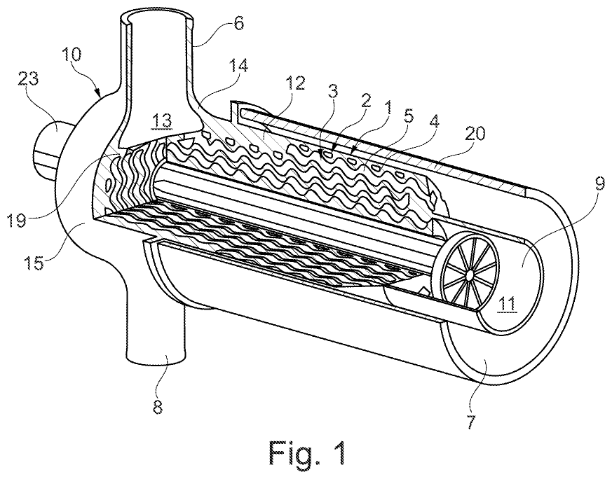

FIG. 1 shows a perspective view of a recuperator burner, partially cut, comprising a ceramic recuperator according to a first embodiment,

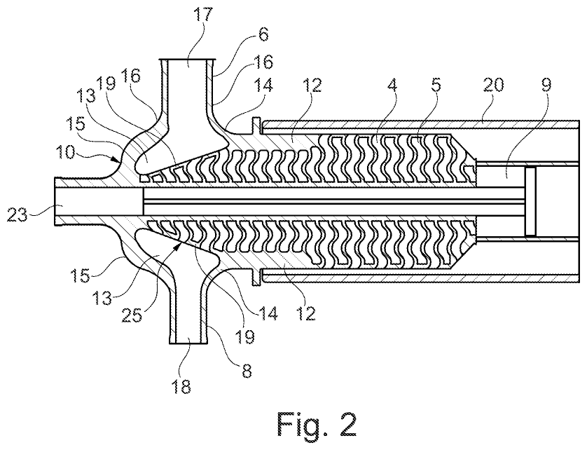

FIG. 2 shows a longitudinal section of the recuperator burner as shown in FIG. 1,

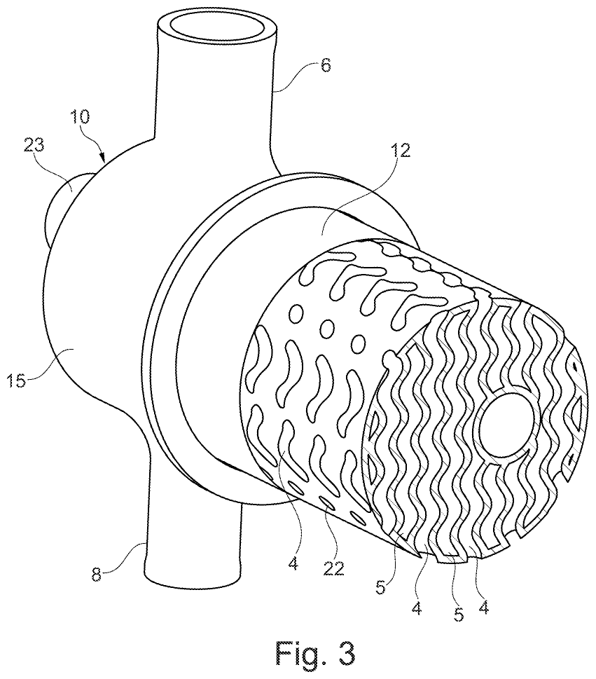

FIG. 3 shows a cross-section of the recuperator burner according to FIG. 1,

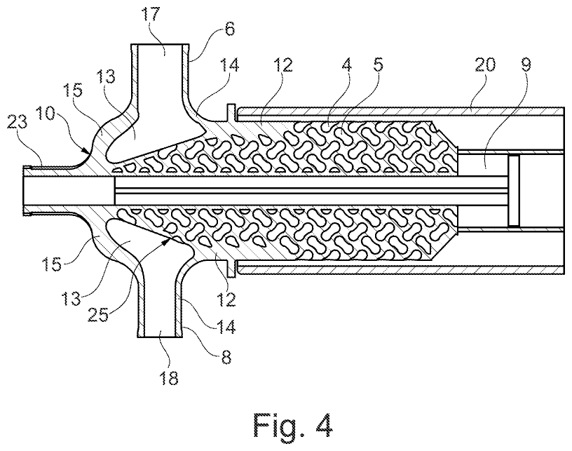

FIG. 4 shows a further longitudinal section of the recuperator burner according to FIG. 1,

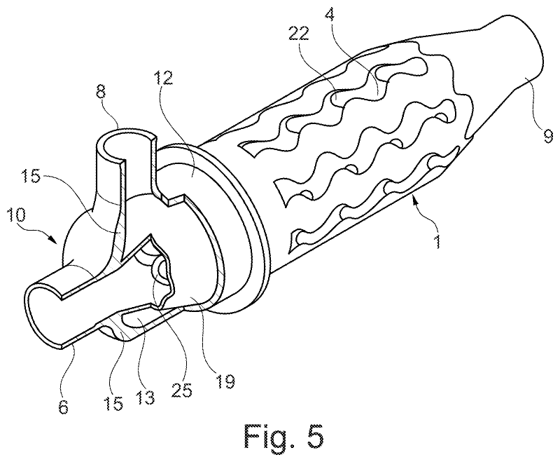

FIG. 5 shows a perspective, partially sectioned view of a recuperator without a jacket tube according to a second embodiment of a recuperator burner,

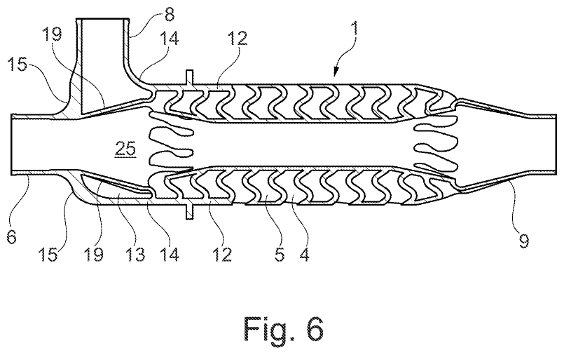

FIG. 6 shows a longitudinal section of a recuperator as shown in FIG. 5,

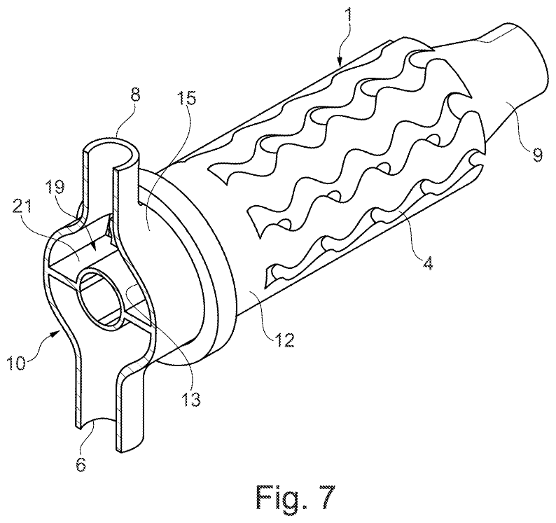

FIG. 7 shows a perspective, partially sectioned view of a recuperator without a jacket tube according to a third embodiment of a recuperator burner,

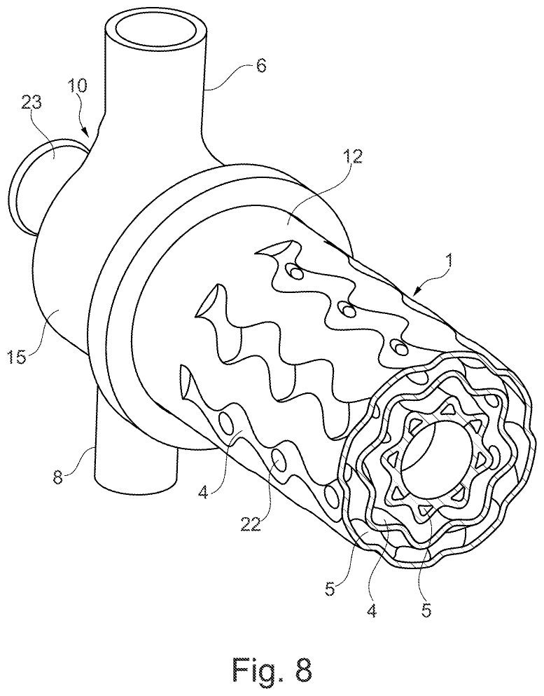

FIG. 8 shows a cross-section of a recuperator according to a fourth embodiment of a recuperator burner,

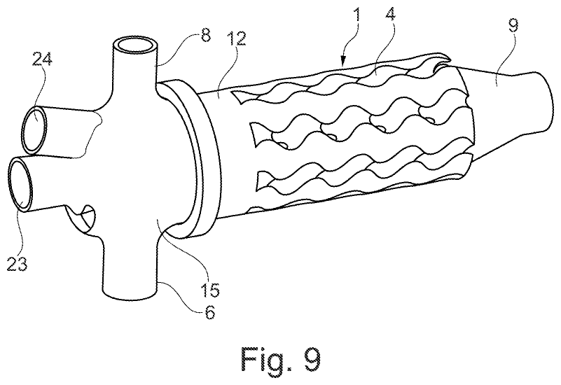

FIG. 9 shows a perspective, partially sectioned view of a recuperator without a jacket tube according to a fifth embodiment of a recuperator burner.

The invention relates to a recuperator burner which can be divided into three areas independently of the relevant functional areas, namely a connection area with burner inlet, a recuperator area and a flame outlet with burner outlet, as described in detail below.

FIG. 1 to FIG. 4 show a first embodiment of a recuperator burner, comprising a recuperator 1, which can be made of a metallic and/or ceramic material, for example. The recuperator 1 has two separate flow systems 2, 3, each with at least one flow channel 4, 5 being open on both sides, for guiding counter-flowing fluids. The at least two fluids can enter/exit via intake inputs 6, 7 and offtake outputs 8, 9 at the opposite ends of the burner inlet 10 and the burner outlet 11.

Concerning the counter-flowing fluids, one is formed by combustion air to be preheated and the other by an exhaust gas from the burner. In the embodiment shown in FIG. 1 to FIG. 4, the combustion air to be preheated flows through the flow channel 5 and the exhaust gas flows through the outwardly open flow channel 4, which is sealed by an adjacent recuperator jacket 20. A heat transfer body 12 is provided as the recuperator 1, which accommodates the two flow systems 2, 3 in a heat transfer body 12 made of one piece, the jacket-shaped outer wall section 14 of which provides a flow pot 13 at the burner inlet 10 comprising the input 6 and output 8 integrally attached.

As shown in FIG. 2 in particular, the input 6 for combustion air or fresh air to be heated can be positioned at least partially axially overlapping the heat transfer body 12 in order to allow combustion air to be preheated to flow directly to it from the side.

The flow pot 13 can be made by an outer wall section 14 with a wall taper relative to the heat transfer body 12, which shapes a bulbous extension 15 of the heat transfer body 12. The bulbous extension 15 can also be provided with shoulder sections 16 for the one-piece connection of necks 17, 18 for the input 6 for combustion air to be preheated and the output 8 for exhaust gas from the burner.

The flow pot 13 provides an interior space that surrounds at least one guide wall 19 for the fluidically separate guidance of the counter-flowing fluids to the input 6 and output 8.

The at least one guide wall 19 can be shaped as a lateral surface of a rotational body, as shown in the embodiment according to FIG. 5.

The at least one guide wall 19 can insert a space separating system 21 into the flow pot 13 for a transition of the at least one flow channel into the input 6 or the output 8, as shown in FIG. 7.

The at least one guide wall 19 is preferably made in one piece with the heat transfer body 12.

As FIG. 1 to FIG. 4 further show, the at least one flow channel 4, 5 of each of the two flow systems 2, 3 is divided into a plurality of partial flow channels for guiding counter-flowing fluids.

The partial flow channels of one and/or the other flow channel 4, 5 can be fluidically connected through channel wall openings 22.

The at least one flow channel 4, 5, respectively has a number of lined-up tube sections as at least one flow channel 4, 5, wherein the tube sections are made from minimal surface elements and the tube sections are connected in a continuous manner.

The minimal surface elements are preferably formed by triple periodic minimal surfaces. The cell structures resulting from the triple periodic minimal surface can be cubic, cylindrical or spherical.

The first embodiment shown in FIG. 1 to FIG. 4 has a cubic cell structure. FIG. 8 shows an embodiment with a cylindrically shaped cell structure.

The recuperator burner 1 further comprises, for example, a combustion gas connecting piece 23 for a combustion tube passing through the heat transfer body 12, via which combustion gas can be fed to the burner outlet 11. Instead of a combustion tube, a combustion gas passage can also be integrally molded into the heat transfer body 12 from the combustion gas connecting piece 23.

As FIG. 9 shows, at least one third and/or fourth flow system, each with at least one flow channel open on both sides for at least one third and/or fourth fluid, can be integrated into the heat transfer body.

For the at least third and/or fourth flow system, an inlet and/or outlet connecting piece 24 can be integrally formed on the flow pot.

FIG. 1 to FIG. 4 also show that the heat transfer body 12 can have an inner body section 25 through which air can flow, which can be positioned so that it extends into the flow pot 13, as a result of which the combustion air to be preheated can flow directly onto it from the side. An acute or obtuse flow angle can be formed in the area of the input 6 as well as the output 8.

As the embodiment according to FIG. 1 to FIG. 4 shows, the input 6 and the output 8 can, for example, be positioned opposite each other on the recuperator 1. The second embodiment according to FIG. 5 and FIG. 6 shows connecting pieces for the input 6 and output 8 arranged at an angle to each other.

FIG. 7 shows a third embodiment with opposing connecting pieces for the input 6 and output 8 and a space separation system 21 in the flow pot 13, as described above.

An all-ceramic version of the recuperator 1 is preferably monolithic. The ceramic is preferably made of silicon infiltrated silicon carbide. Non-oxide and/or oxide ceramic materials are particularly preferred, especially silicon-infiltrated, reaction-bonded silicon carbide (RBSiC), silicon-infiltrated, reaction-bonded silicon carbide/boron carbide (RBSiC/B4C), silicon-infiltrated silicon carbide (RBSiC), silicon nitride-bonded silicon carbide (NSiC), pressureless sintered silicon carbide (SSiC), recrystallized silicon carbide (RSiC), aluminium oxide, silicate-bonded silicon carbide, zirconium oxide.

1. Recuperator burner comprising a recuperator, which has two separate flow systems provided for guiding counter-flowing fluids, each system comprising at least one flow channel being open on both sides, and the at least two fluids entering/leaving via intake inputs and offtake outputs at opposite ends of the burner inlet and burner outlet, and one of the fluids is set up by a combustion air to be preheated and the other by an exhaust gas of the burner, wherein the recuperator accommodates said two flow systems in a heat transfer body which is made of one piece and whose jacket-shaped outer wall section integrally attached.

2. Recuperator burner according to claim 1, characterized in that the flow pot is defined by an outer wall section having a wall tapering, which forms a bulbous extension of the heat transfer body having shoulder sections for the integrally connection of necks for combustion air to be preheated and the output for exhaust gas from the burner.

3. Recuperator burner according to claim 1, characterized in that an interior space of the flow pot surrounds at least one guide wall for the fluidically separate guidance of the counter-flowing fluids to the input and output.

4. Recuperator burner according to claim 3, characterized in that the at least one guide wall is shaped as a lateral surface of a body of revolution.

5. Recuperator burner according to claim 3, characterized in that the at least one guide wall inserts a space separating system into the flow pot for a transition of the at least one flow channel into the input or the output.

6. Recuperator burner according to claim 3, characterized in that the at least one guide wall is formed integrally with the heat transfer body.

7. Recuperator burner according to claim 1, characterized in that the at least one flow channel of each of the two flow systems is divided into a plurality of partial flow channels for guiding counter-flowing fluids.

8. Recuperator burner according to claim 7, characterized in that the partial flow channels of one and/or the other flow channel can be fluidically connected by channel wall openings.

9. Recuperator burner according to claim 1, characterized in that the at least one flow channel in each case has a number of lined-up tube sections as at least one flow-through channel, and the tube sections being formed from minimal surface elements and the tube sections being connected in a continuous manner.

10. Recuperator burner according to claim 1, characterized in that the minimum surface elements are set up by triple periodic minimum surfaces.

11. Recuperator burner according to claim 10, characterized in that the cell structures resulting from the triple periodic minimum surface are cubic, cylindrical or spherical.

12. Recuperator burner according to claim 1, characterized in that at least one third and/or fourth flow system, each with at least one flow channel open on both sides for at least one third and/or fourth fluid, is integrated into the heat transfer body.

13. Recuperator burner according to claim 12, characterized in that an inlet and/or outlet connection piece for the at least third and/or fourth flow system is integrally attached to the flow pot.

14. Recuperator burner according to claim 1, characterized in that the heat transfer body has a flow-through inner body section which can be positioned extending into the flow pot, as a result of which the latter can be directly flowed against laterally with combustion air to be preheated.

15. Recuperator burner according to claim 14, characterized in that an acute or obtuse angle of flow can be formed in the region of the input.

16. Recuperator burner according to claim 1, characterized in that the input and the output are positioned opposite each other on the recuperator in an aligned manner.

17. Recuperator burner according to claim 1, characterized in that a combustion tube is introduced at the burner inlet, which opens into the combustion chamber and which extends through the heat transfer body.

18. Recuperator burner according to claim 1, characterized in that the heat transfer body is formed from a ceramic and/or metallic material.

19. Recuperator burner according to claim 1, characterized in that the recuperator is designed as a ceramic recuperator which is monolithic.

20. Recuperator burner according to claim 18, characterized in that the ceramic is made of a non-oxide and/or oxide ceramic material, in particular silicon-infiltrated, reaction-bonded silicon carbide (RBSiC), silicon-infiltrated, reaction-bonded silicon carbide/boron carbide (RBSiC/B4C), silicon-infiltrated silicon carbide (RBSiC), silicon nitride-bonded silicon carbide (NSiC), pressureless sintered silicon carbide (SSiC), recrystallized silicon carbide (RSiC), aluminium oxide, silicate-bonded silicon carbide, zirconium oxide.
